(19) United States
(12) Patent Application Publication
(10) Pub. No.: US 2004/0223829 A1
(43) Pub. Date: Nov. 11, 2004

(54) Quick release threaded fastener

(76) Inventors: Jesse H. Barnett, Virginia Beach, VA (US); Michael J. Barnett, Milwaukee, WI (US)

Correspondence Address: MEREK, BLACKMON & VOORHEES, LLC, 673 S. WASHINGTON ST., ALEXANDRIA, VA, 22314, US

(21) Appl. No.: 10/431,444

(22) Filed: May 8, 2003

(51) Int. Cl. F16B 37/08

(52) U.S. Cl. 411/433

(57) ABSTRACT

A quick release fastener comprising a threaded shaft and a split nut arranged to release threads of the shaft when spread open by squeezing. The shaft may be, for example, a screw or a bolt. The nut is longitudinally split into upper and lower mirror image sections such that half of each turn of the threads is contained within a jaw of the upper section and the other half of each turn is contained within a jaw of the lower section. A handle projects from each jaw, enabling the nut to be opened fashion by squeezing the handles together. The fastener is utilized with an appliance bearing a passageway configured to receive the fastener. The passage way is configured such that slight unthreading of the nut allows the jaws to expand, thereby releasing the shaft from the nut. The appliance may be a commode having a toilet seat arranged to be retained by one or more of the novel fasteners.

### BACKGROUND OF THE INVENTION

1. Field of the Invention

The present invention relates to a readily assembled and released fastening system centered around a quick release nut and an associated bolt. A principal contemplated application of the invention is for mounting a toilet seat to an associated commode.

2. Description of the Prior Art

Some household appliances such as commodes must periodically be cleaned by washing. As a commode is usually located in a room having other facilities, washing is usually performed by hand. Each component of a commode must be carefully scrubbed to eliminate bacteria, odors, and unsightly contamination. This is both unpleasant and also inefficient.

One approach to expediting cleaning is to disassemble the commode. This exposes all surfaces to enable rapid yet effective cleaning. One way to accomplish this end is to provide a readily disassembled fastener enabling the toilet seat to be removed from the commode.

U.S. Pat. No. 4,680,816, issued to Louie V. Colombani on Jul. 21, 1987, features disassembly of a toilet seat assembly for cleaning, but fails to show the novel nut.

U.S. Pat. Nos. 594,526, issued to Max Glauber on Nov. 30, 1897, 900,843, issued to William and Fred G. Folberth on Oct. 13, 1908, 1,329,126, issued to Frank Leming on Jan. 27, 1920, 2,118,361, issued to Ethan A. Schaeffer, Jr. on May 24, 1938, and 5,152,651, issued to Marcel Artéon on Oct. 6, 1992, each set forth a high speed nut formed in mating halves which close over a threaded rod. In each case, the high speed nut is released by squeezing two opposed handle members in the manner of the present invention. However, the novel nut has characteristics not seen in the prior art.

None of the above inventions and patents, taken either singly or in combination, is seen to describe the instant invention as claimed.

### SUMMARY OF THE INVENTION

The present invention provides a quick release fastener suitable for clamping two objects together. The fastener includes a member having a threaded shaft, such as a bolt or a screw, and a nut which is pinched or squeezed to disengage the threaded shaft. The nut is inexpensively and advantageously formed unitarily or monolithically from a constituent material such as an elastomer, having a live hinge joining together two mirror image threaded jaws. An extension or handle projects from each jaw to facilitate squeezing to release the nut.

Optionally, the nut is formed such that the constituent material have spring characteristics urging the jaws into the closed position. This promotes ready threading onto a threaded shaft.

The invention may also be regarded as comprising an appliance utilizing the nut and its associated member having a threaded shaft. An exemplary application is to clamp a toilet seat to a commode. The quickly released fastener aids in disassembling the toilet for cleaning.

Accordingly, it is a principal object of the invention to provide a quick release fastener suitable for clamping two objects together.

It is another object of the invention that the nut be formed monolithically and incorporate a live hinge.

It is an optional object of the invention that the nut have spring characteristics urging the jaws together.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an exploded side elevational view of an embodiment of the novel quick release fastener.

FIG. 2 is a side cross sectional view of the fastener of FIG. 1, showing the nut as it would appear when being squeezed to disengage from the threaded shaft.

FIG. 3 is a side elevational, partly cross sectional view of a commode utilizing the novel quick release fastener to fasten a toilet seat thereto, drawn to reduced scale.

FIG. 4 is a side elevational, partly cross sectional detail view taken from the right of FIG. 3, drawn to enlarged scale.

### DETAILED DESCRIPTION OF THE PREFERRED EMBODIMENTS

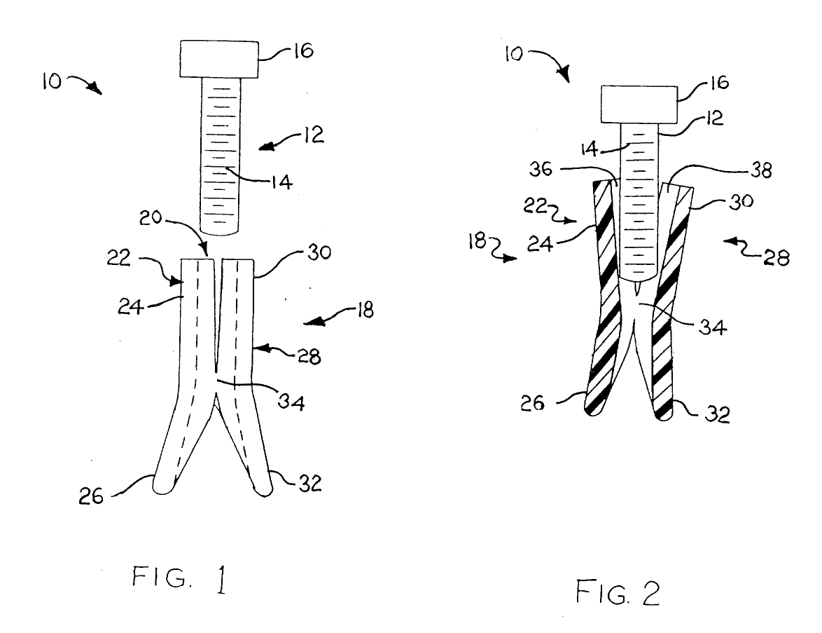

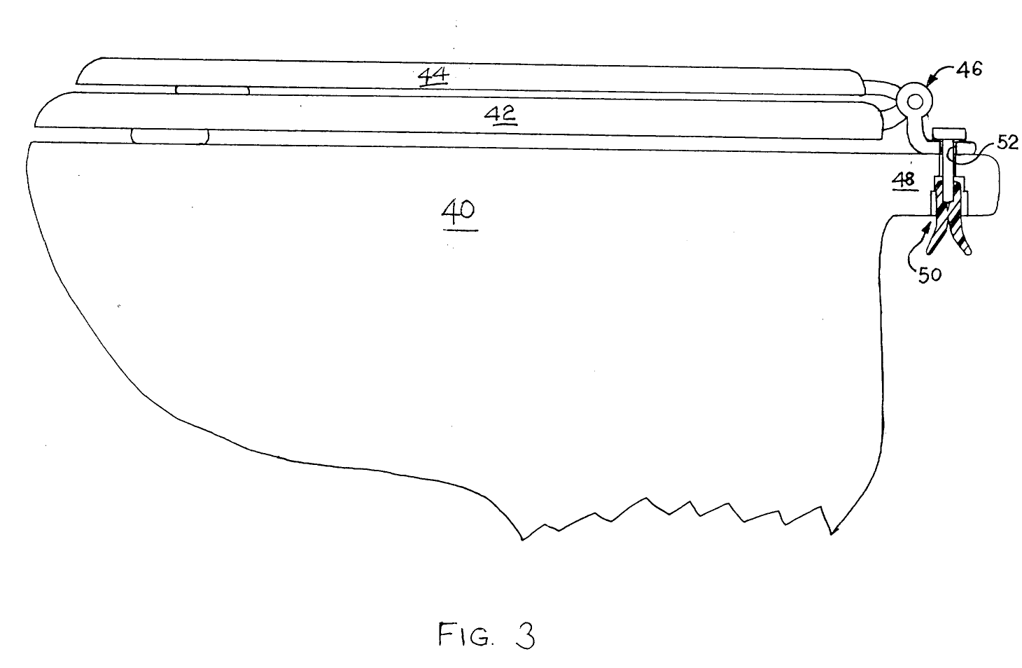

Turning now to FIGS. 1 and 2 of the drawings, quick release fastener assembly 10 is seen to comprise a first member comprising a shaft 12 bearing male threads 14 and an enlarged head 16, and a quick release nut 18. Quick release nut 18 bears female threads 20 which are threadably engageable with male threads 14. Quick release nut 18 is formed monolithically to include a first section 22 having a first jaw 24 terminating in a first projecting handle 26, and a second section 28 having a complementing second jaw 30 terminating in a second projecting handle 32. First section 22 and second section 28 are joined at a live hinge 34 which pivotally connecting first section 22 to second section 28 at a pivot point.

FIG. 1 depicts condition of quick release nut 18 when no force is imposed on handles 26, 32. In this condition, jaws 24, 30 approach one another so that threads 20 will readily engage threads 14 of shaft 12. FIG. 2 shows how jaws 24, 30 spread apart when handles 26, 32 are squeezed towards one another. Quick release nut 18 is fabricated from a constituent material such as a suitable elastomer which is sufficiently elastic to impart spring characteristics urging jaws 24, 30 to the closed position shown in FIG. 2.

Sections 22, 28 each have a semi-cylindrical trough 36 or 38 formed therein, the respective trough bearing female threads. Sections 22, 28 are substantially mirror images of one another, arranged such that projecting handles 26, 32 are located on one side of a pivot point established by live hinge 34, with jaws 22, 26 located on the other side of the same pivot point. Quick release nut 18 may therefore be released by squeezing handles 26, 32 towards one another, wherein jaws 24, 30 responsively spread apart from one another.

The trough of section 22 contains half of female threads 20, while the trough of section 26 contains the balance of female threads 20. Sections 22, 26 are arranged in complementary fashion such that half of each turn of threads 20 is contained within section 22 and the other half of each turn of threads 20 is contained within section 26. When sections 22, 26 meet or closely approach one another, threads 20 are in operable alignment, permitting threads 14 of shaft 12 to thread to quick release nut 18.

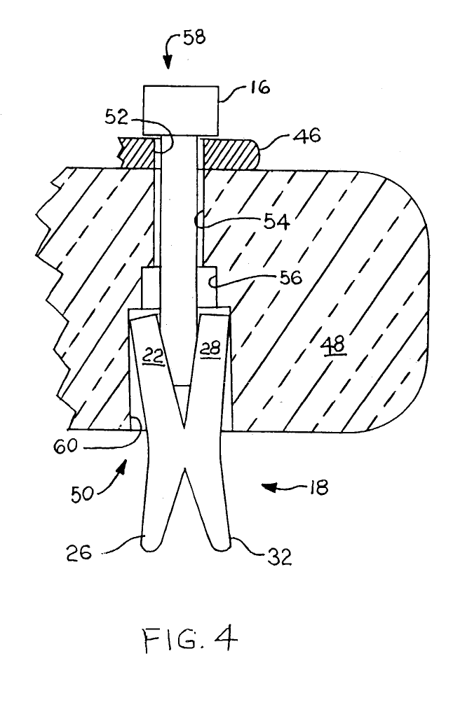

FIG. 3 shows an exemplary application of the novel fastener assembly 10 to mount a movable closure to an appliance. In the example of FIG. 3, the appliance is a commode 40 which is covered by a toilet seat 42 and cover 44. Seat 42 and cover 44 are pivotally mounted to a hinge assembly 46 mounted to a structural wall 48 of the body of commode 40. Wall 48 bears a passageway 50 formed therein. Quick release fastener assembly 10 passes through passageway 50 and through a hole 52 formed in a structural wall formed in hinge assembly 46. Quick release fastener 10 releasably clamps hinge assembly 46 to commode 40 by interference fit. Interference fit is established by enlarged head 16 disposed at the end of shaft 12 at one end, and at the other end by nut 18. Enlarged head 16 engages the base of hinge assembly 46 while nut 18 engages wall 48 of commode 40.

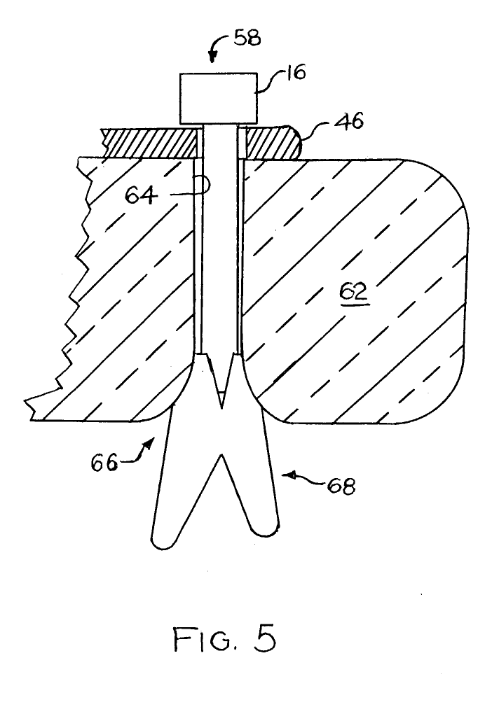

This is shown in greater detail in FIG. 4, wherein it is seen that passageway 50 formed in wall 48 is of variable diameter, having three steps. The smallest portion 54 is of sufficient diameter to allow shaft 12 to pass through, but prevents nut 18 from escaping through the upper end of passageway 50 in the depiction of FIG. 4, by interference. The next portion 56 is of sufficient diameter to receive nut 18 when nut 18 is fully compressed, or closed over shaft 12. The compressed or closed condition is shown in FIG. 3. To release fastener 10, the threaded member of quick release fastener 10, which is a bolt 58, is slackened until nut 18 can be pulled out from section 56 to section 60. Handles 26, 32 of nut 18 are squeezed so that jaws 22, 28 expand outwardly in section 60 as depicted in FIG. 4, thereby releasing engagement of threads 14 of shaft 12. Nut 18 can then be pulled away from bolt 58. Hinge assembly 46 can be lifted from wall 48 of commode 40. In summary, commode 40 has a passageway 50 which is dimensioned and configured to receive and engage quick release fastener 10 by interference fit when head 16 of bolt 58 interferingly engages that portion of hinge assembly 46 abutting wall 48 of commode 40, shaft 12 of bolt 58 is passed through hinge assembly 46, and quick release nut 18 threadably engages said shaft and interferingly engages wall 48 of commode 40. Reassembly is performed by reversing the process of disassembly.

FIG. 5 shows a preferred embodiment of the invention wherein a commode (not shown in its entirety) has a wall 62 which corresponds to wall 48 of the embodiment of FIG. 4. However, a passageway 64 has a gradually flared lower end 66 rather than the steps 54, 56, 60 of the embodiment of FIG. 4. The flared lower end 66 may, for example, be conical or frustoconical, or alternatively, may display curvature when viewed in silhouette, or may otherwise depart from strictly conical or frustoconical configuration. A quick release nut 68, which is functionally similar to nut 18 of the embodiment of FIG. 4, is dimensioned and configured to cooperate at its outer contour with the generally conical lower end 66 of passageway 64. In other respects, nut 68 has the construction and properties of nut 18. Hinge assembly 46 and bolt 58 of the embodiment of FIG. 4 may be utilized in the embodiment of FIG. 5. The difference between FIG. 4 and FIG. 5 lies in eliminating steps 54, 56, and 60 of FIG. 4 in favor of the gradual, unstepped configuration of passageway 64 of FIG. 5.

The present invention may be varied or modified without departing from the inventive concept. For example, bolt 58 could be a screw or any other type of male threaded fastener. In another example, part of shaft 12 could be devoid of threads 14.

The present invention may be varied or modified without departing from the inventive concept. For example, bolt 58 could be a screw or any other type of male threaded fastener. In another example, part of shaft 12 could be devoid of threads 14.

The novel fastener assembly 10 could be utilized to form a hinge pin for the hinge assembly to which the toilet seat and cover are pivotally mounted, or for use in other appliances for securing a closure to a cabinet thereof, or in still other functions.

It is to be understood that the present invention is not limited to the embodiments described above, but encompasses any and all embodiments within the scope of the following claims.

We claim:

1. A quick release fastener assembly comprising:
a first member comprising a shaft bearing male threads; and
a quick release nut bearing female threads threadably engageable with said male threads of said shaft, wherein said quick release nut is formed monolithically to include
a first section having a first jaw containing half of said female threads and terminating in a first projecting handle,
a second section having a complementing second jaw containing the balance of said female threads and terminating in a second projecting handle, and
a live hinge pivotally connecting said first section to said second section at a pivot point,
wherein said second section is substantially a mirror image of said first section arranged such that said first projecting handle and said second projecting handle are located on one side of said pivot point and approach one another when squeezed together while said first jaw and said second jaw are located on an opposite side of said pivot point and spread apart from one another when said first projecting handle and said second projecting handle are squeezed together.

2. The quick release fastener assembly according to claim 1, wherein said shaft of said first member includes an enlarged head.

3. The quick release fastener assembly according to claim 1, wherein said first member is a bolt.

4. The quick release fastener assembly according to claim 1, wherein said first member is a screw.

5. The quick release fastener assembly according to claim 1, wherein said quick release nut is fabricated from an elastomer.

6. The quick release fastener assembly according to claim 1, wherein said quick release nut is fabricated from a constituent material providing spring characteristics urging said first jaw and said second jaw to a closed position.

7. An appliance having a passageway formed therein and a quick release fastener selectively engageable with and removable from said passageway, for securing an external object to said appliance, comprising:
an appliance body having a structural wall bearing a passageway extending entirely therethrough; and
a quick release fastener comprising
a first member comprising a shaft bearing male threads and having an enlarged head, and
a quick release nut bearing female threads threadably engageable with said male threads of said first member, wherein said quick release nut is formed monolithically to include a first section having a first jaw containing half of said female threads and terminating in a first projecting handle, a second section having a complementing second jaw containing the balance of said female threads and terminating in a second projecting handle, and a live hinge pivotally connecting said first section to said second section at a pivot point, wherein said second section is substantially a mirror image of said first section arranged such that said first projecting handle and said second projecting handle are located on one side of said pivot point and approach one another when squeezed together while said first jaw and said second jaw are located on an opposite side of said pivot point and spread apart from one another when said first projecting handle and said second projecting handle are squeezed together.

8. The appliance according to claim 7, wherein said appliance body comprises a commode, and said appliance further comprises a toilet seat which is releasably fastenable to said commode by said quick release fastener, wherein said toilet seat has a structural wall bearing a hole dimensioned and configured to receive said quick release fastener and to engage said quick release fastener by interference fit when said quick release fastener engages said commode by interference fit between said structural wall of said toilet seat with said enlarged head of said shaft of said quick release fastener, and said shaft of said quick release fastener is passed through said hole of said toilet seat and said quick release nut threadably engages said shaft and interferingly engages said commode.
